(19) United States
(12) Patent Application Publication
(10) Pub. No.: US 2017/0038739 A1
(43) Pub. Date: Feb. 9, 2017

(54) TIME DISPLAY DEVICE

(71) Applicant: HONDA MOTOR CO., LTD., Tokyo (JP)

(72) Inventors: Yusuke NAKAMURA, WAKO-SHI (JP); Yosuke FUCHIWAKI, WAKO-SHI (JP); Atsuyuki SUZUKI, WAKO-SHI (JP); Nobuaki ASAHARA, WAKO-SHI (JP)

(21) Appl. No.: 15/227,084

(22) Filed: Aug. 3, 2016

(30) Foreign Application Priority Data
Aug. 6, 2015 (JP) 2015-156027

(51) Int. Cl. G04G 7/00

(52) U.S. Cl. CPC G04G 7/00

(57) ABSTRACT

A time display device having a function of displaying time information which may display a user-setting based time matching a user preference or a correct time in proper timing is provided. The device comprises a processing device configured to measure and display a time based on a first time setting information which is input or previously input thereto, in response to a predetermined device being connected thereto acquire a second time setting information from the predetermined device, and measure and display a time based on the second time setting information instead of the time based on the first time setting information. The processing device is further configured to, after starting to display the time based on the second time setting information, continue to display the time based on the second time setting information until the time display device is turned off, even though the predetermined device is disconnected.

### FIELD OF THE INVENTION

This invention relates to a device (a time display device) having a function of displaying time information and especially a time display device performing a time synchronization based on time information from an external device connected thereto.

### BACKGROUND OF THE INVENTION

In a device having a function of displaying time information (i.e., a time display device), it is desirable generally that a time displayed on the device (a display time) matches accurately with the local standard time in a region covering a current position of the device. Thus, it is desirable that the display time is corrected automatically when the display time becomes inaccurate due to an error in a time measurement function of a timer used in the device and/or when the display time deviates from the local standard time, e.g., as the device moves with a vehicle from one time zone to another.

However, on the other hand, some users want to give some time shift against the local standard time intentionally to the display time of the device in order to e.g. get some time margin by making their action plan based on the shifted time. Such preference about the time display is different from one user to another, and thus, the display time being accurate does not always ensure user's convenience

As one conventional approach for updating (or correcting) a time information in an on-vehicle clock device to a reference time, it is known that the time information in the on-vehicle clock device is updated based on a cellular phone brought into the vehicle (see Patent Document 1). The cellular phone acquires reference time information repeatedly from a base station at predetermined time interval. When brought into the vehicle, the phone searches for communication terminals and establishes communication with the on-vehicle clock device. Then, the phone sends the acquired reference time information to the clock device in response to receiving a request from the device.

However, in the conventional approach described above, even if a user sets an inaccurate time intentionally to the on-vehicle clock device, such use's set time would be overwritten at the update with the reference time. Therefore, this approach can not satisfy the above-described user's preference about a time display.

As an approach for satisfying such user's preference, one may have an idea, for example, that the clock device stores the user set time. The clock device may display the reference time acquired from the cellar phone while the phone is connected to the device. And the device may display the user set time again after the phone is disconnected from the device.

However, in the approach according to the above-described idea, different times each based on different bases (i.e. the user set time and the reference time) are displayed alternately each time the cellar phone is connected to and disconnected from the clock device, so that the user may become prone to recognize the time incorrectly. For example, if a navigation is performed relying on such unstable time information as described above which varies depending on which base is currently used, an expected time for arrival to a destination displayed on a navigation screen also varies, which may confuse a user. For another example, in a case that the clock device is connected and synchronized with the cellar phone in a vehicle and the clock device moves across a boundary of a time zone which causes time change by several hours in the display time, when the clock device is disconnected afterwards from the cellar phone and resumes displaying the user set time, the display time would change significantly. In this case, such significant change in the display time might not result in user's misrecognition about the current time, but the user need to connect the clock device to a cellar phone each time the user wants to know the correct current time, which may bother the user.

### PRIOR ART DOCUMENTS

Patent Document 1: JP2002-300640A

### SUMMARY OF THE INVENTION

### Problems to be Solved by the Invention

From the background described above, with respect to a device having a function of displaying time information, it is desired that a correct time and a user-setting based time matching a user preference are displayed in proper timing.

### Solution to the Problems

According to one aspect of the invention, a time display device having a function of displaying time information comprises a processing device. The processing device is configured to measure and display a time based on a first time setting information which is input or previously input thereto, in response to a predetermined device being connected thereto acquire a second time setting information from the predetermined device, measure and display a time based on a second time setting information instead of the time based on the first time setting information, and after starting to display the time based on the second time setting information continue to display the time based on the second time setting information until the time display device is turned off, even though the predetermined device is disconnected.

According to another aspect of the invention, the processing device is further configured to continue a measurement of the time based on the first time setting information even after the time display device is turned off, and display the time based on the first time setting information at a time when the time display device is turned on.

According to another aspect of the invention, the time display device is an audio device or a navigation device having a display.

According to a still another aspect of the invention, a vehicle is equipped with the time display device according to any one of the aspects described above.

### BRIEF DESCRIPTION OF THE DRAWINGS

FIG. 1 shows a constitution of a time display device according to an embodiment of the present invention.

FIG. 2 shows a process flow diagram of the time display device shown in FIG. 1.

FIG. 3A shows an exemplary change of the time display on the time display device shown in FIG. 1.

FIG. 3B shows an exemplary change of the time display on the time display device shown in FIG. 1.

FIG. 3C shows an exemplary change of the time display on the time display device shown in FIG. 1.

FIG. 3D shows an exemplary change of the time display on the time display device shown in FIG. 1.

FIG. 3E shows an exemplary change of the time display on the time display device shown in FIG. 1.

FIG. 3F shows an exemplary change of the time display on the time display device shown in FIG. 1.

FIG. 3G shows an exemplary change of the time display on the time display device shown in FIG. 1.

FIG. 4 shows an exemplary indication of time synchronization on the time display device shown in FIG. 1.

FIG. 5 shows an example of a text message displayed on the time display device shown in FIG. 1.

### DESCRIPTION OF EMBODIMENTS

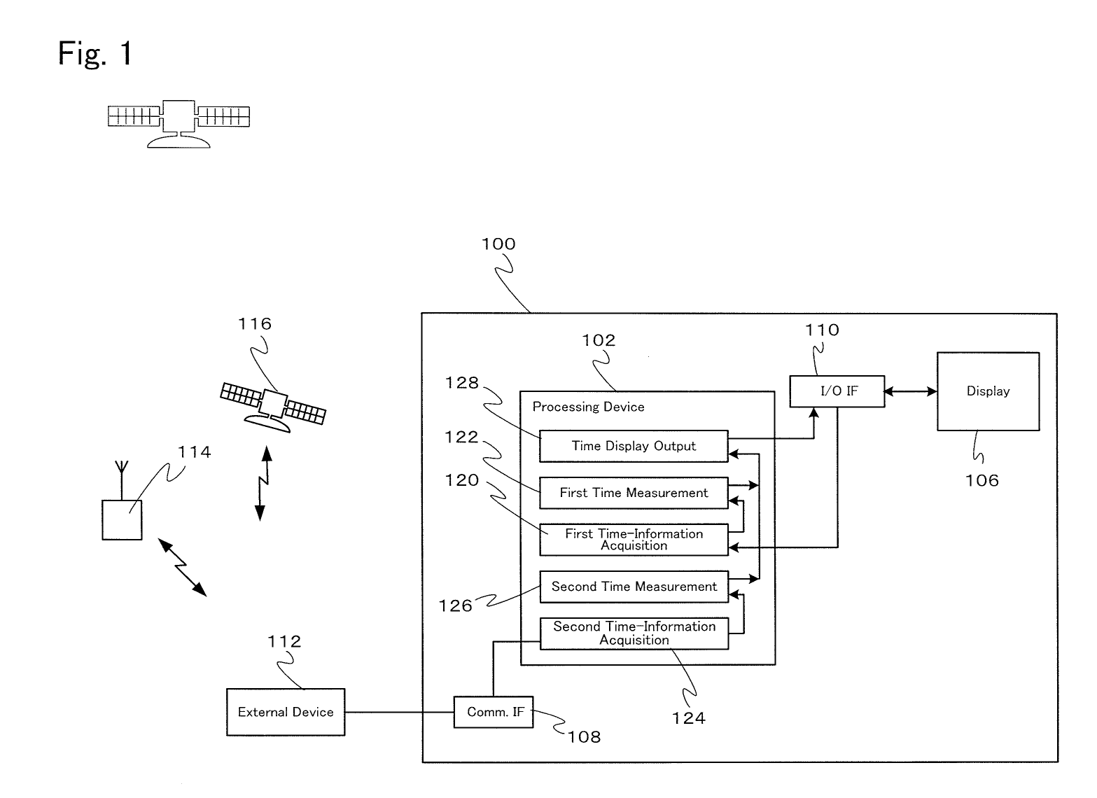

Embodiments of the present invention are described below with reference to the drawings. FIG. 1 is a block diagram of a time display device according to an embodiment of the present invention.

The time display device 100 may be, for example, a so-called display audio (DA) which has a display device and provides an audio function including e.g. functions of receiving radio broadcast, playing back music, etc. It is to be noted that the time display device 100 is not limited to such display audio and may beany other type of device such as a navigation device mounted on a vehicle.

The time display device 100 comprises a processing device 102, a display 106, a communication interface (communication IF or comm. IF) 108, and an input/output interface (I/O IF) 110.

The communication IF 108 is an interface through which the processing device 102 acquires time information from an external device 112. The communication IF 108 may be e.g., an interface conforming to a communication standard such as USB (Universal Serial Bus). In this embodiment, the time display device 100 is connected to the external device 112 with a wired transmission path. In another embodiment, the time display device 100 may be connected to the external device 112 with wireless transmission such as Wi-Fi.

The external device 112 may be e.g. a multi-function mobile phone such as a smartphone, or a portable information terminal equipment such as a portable PC (Personal Computer). The external device 112 acquires a current standard time by receiving information about a local standard time (LST) at a current position of the external device 112 which is wirelessly sent from a wireless base station 114 for mobile phones and/or a GPS satellite 116. And, the external device 112 is connected to the time display unit 100 by a user as necessary.

The display 106 may be a display device which has also a function as an input device. The display 106 may comprise e.g. an LCD (liquid crystal display) and a touch panel mounted on a screen of the LCD.

The I/O IF 110 is an interface device through which the processing device 102 inputs/outputs data and/or signals from/to other external devices including the display 106. In this embodiment, particularly, the I/O IF 110 provides the display 106 with the time information from the processing device 102 and provides the processing device 102 with information entered through the touch screen of the display 106.

The processing device 102 may be a computer comprising a processor such as CPU (Central Processing Unit), ROM (Read Only Memory) storing a program, RAM for temporary storing of data, etc. The processing device 102 has a first time-information acquisition unit 120, a first time measurement unit 122, a second time-information acquisition unit 124, a second time measurement unit 126, a time display output unit 128. These units above in the processing device 102 are realized by the processing device 102 as a computer executing a program which may be stored in any computer-readable storage medium. Alternatively, all of or a part of these units may be realized by hardware units each including at least one electrical component.

The first time-information acquisition unit 120 acquires information of user setting about a time which is entered through a touch screen of the display 106. This information of user setting about a time corresponds to a first time setting information. This time setting information may be information about a current time of day which is entered by a user. More specifically, the user enters through the touch screen time data of hour, minute, second. And the user inputs a command to activate the time data (e.g. by pushing a specific button). Then, the first time-information acquisition unit 120 acquires through the I/O IF 110 the time indicated by the entered time data as a current time of day at a moment when the command is input.

On the basis of the user-entered time data (i.e. the first time setting information) acquired by the first time-information acquisition unit 120, the first time measurement unit 122 carries out time measurement using a timer (not shown) in the processing device 102 and provides a current time calculated through the time measurement to the time display output unit 128 as a user-setting based time. Particularly, the time measurement based on the user-entered time data continues even after the time display device 100 is turned off, e.g. by using an internal battery (not shown).

The second time-information acquisition unit 124 detects whether the external device 112 is connected, by monitoring the communication IF 108. If the device 112 is connected, the unit 124 provides the time display output unit 128 with a notice of the connection of the external device 112 and acquires information about a time of day of the external device 112 (e.g. information about a local standard time which the device 112 acquired from e.g. the wireless base station 114) through the communication IF 108. Here, the information about a time of day of the external device 112 corresponds to a second time setting information. And, the second time-information acquisition unit 124 detects whether the external device 112 is disconnected, by monitoring the communication IF 108. If the device 112 is disconnected, the unit 124 provides the time display output unit 128 with a notice of the disconnection of the external device 112.

On the basis of the information about a time of day of the external device 112 acquired by the second time-information acquisition unit 124, the second time measurement unit 126 carries out time measurement using a timer (not shown) in the processing device 102 and provides a current time calculated through the time measurement to the time display output unit 128 as a time synchronized with the external device 112. And, each time the second time-information acquisition unit 124 acquires the information about a time of day of the device 112 from the external device 112, the second time measurement unit 126 carries out time measurement anew on the basis of the acquired information (i.e., the latest information about a time of day of the external device 112 acquired by the second time-information acquisition unit 124) and provides a current time calculated through the time measurement to the time display output unit 128 as a time synchronized with the external device 112.

Further, if the second time-information acquisition unit 124 ceases to acquire the information about a time of day of the external device 112 for some reason such as disconnection of the external device 112, the second time measurement unit 126 continues the time measurement on the basis of the information about a time of day of the external device 112 last acquired by the second time-information acquisition unit 124 and provides a current time calculated through the time measurement to the time display output unit 128 as a time synchronized with the external device 112.

After the time display device 100 is turned on, the time display output unit 128 receives the current time calculated by the first time measurement unit 122 (i.e., the user-setting based time) and displays the received current time on the display 106 through the I/O IF 110. Since the first time measurement unit 122 continues the time measurement based on the user-entered time data even after the time display device 100 is turned off as described above, the user-setting based time calculated through the time measurement based on the user-entered time data last acquired by the first time-information acquisition unit 120 is displayed at a time when the time display device 100 is turned on.

After that, when the external device 112 is connected to the time display device 100, the time display output unit 128 receives the current time calculated by the second time measurement unit 126 (i.e., the time synchronized with the external device 112) in response to reception of the notice of the connection of the external device 112 from the second time-information acquisition unit 124. And then, the time display output unit 128 displays on the display 106 through the I/O IF 110 the received time synchronized with the external device 112 instead of the above user-setting based time.

Further, once the time display output unit 128 displays on the display 106 the time synchronized with the external device 112 as described above, even if the notice of the disconnection of the external device 112 is received thereafter from the second time-information acquisition unit 124, the unit 128 continues to receive the time synchronized with the external device 112 from the second time measurement unit 126 and continues to display on the display 106 the time synchronized with the external device 112. And, the time display output unit 128 continues to display the time synchronized with the external device 112 until the time display device 100 is turned off.

The time display device 100 having the constitution described above displays on the display 106 the user-setting based time while the external device 112 is not connected after the time display device 100 is turned on. And, when the external device 112 is connected, the time display device 100 displays on the display 106 the time synchronized with the external device 112.

Especially, in this embodiment, once the time display device 100 starts to display the time synchronized with the external device 112 as described above, the device 100 continues to display on the display 106 the time synchronized with the external device 112 even if the connection between the time display device 100 and external device 112 is cut.

Herewith, the user may make the time display device 100 display a user-setting based time matching the user's preference at a start of driving a vehicle, while in a case of driving the vehicle across a boundary of a time zone the user may make the device 100 display a correct current time by connecting the external device 112 and may continue driving. And, in the time display device 100, especially, even if the external device 112 is disconnected after carrying out time synchronization by connecting the external device 112, the time synchronized with the external device 112 that is based on the last synchronization with the external device 112 continues to be displayed until the time display device 100 is turned off. Therefore, for example, in one driving cycle from turning-on to turning-off an ignition switch of the vehicle, the time synchronized with the external device 112, if once displayed, continues to be displayed, so that the frequent rapid change of the display time is prevented and user's confusion about time may be reduced.

Further, in the time display device 100, when the user turns off and then turns on again the device 100, the user-setting based time is displayed. Thus, just after a start of a new driving cycle, the user-setting based time is always displayed regardless of whether the displayed time was synchronized in the previous driving cycle, so that the user's confusion about time is prevented (or resolved). For example, in a case that the user-entered time data was entered in a time zone covering a location of a user's home, even if afterwards the vehicle travels across a boundary of the time zone and the time synchronized with the external device 112 is displayed, the user-setting based time based on the above user-entered time data entered in the time zone covering the location of the user's home is always displayed at a time when a new driving cycle is started again at the location of the user's home. Thus, the user may start the new driving cycle without being affected by the time synchronization performed at the time zone boundary during the previous driving cycle.

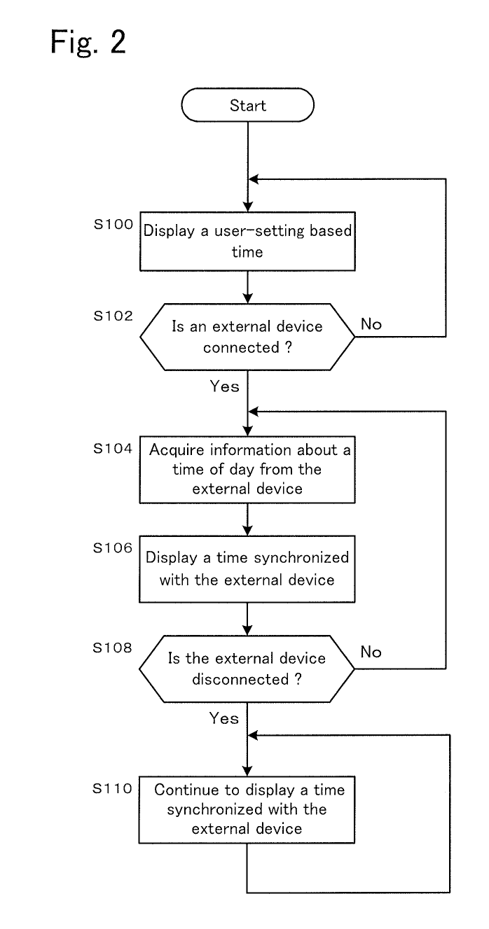

A procedure of the process performed in the processing device 102 of the time display device 100 will now be explained with reference to a flow diagram shown in FIG. 2. In the following description, it is assumed that the first time-information acquisition unit 120 of the time display device 100 already acquires time setting information entered by a user through a touch screen of the display 106 (i.e., the user-entered time data or the first time setting information) and the first time measurement unit 122 already starts the time measurement for calculating a current time on the basis of the acquired user-entered time data. And also, it is assumed that the time measurement continues even after the device 100 is turned off, by using e.g. an internal battery as described above.

First, when the time display device 100 is turned on by e.g. an ignition switch of the vehicle being turned on, the time display output unit 128 receives the user-setting based time from the first time measurement unit 122 and displays on the display 106 through the I/O IF 110 the received time (S100), and the second time-information acquisition unit 124 determines by monitoring the communication IF 108 whether the external device 112 is connected to the time display device 100 (S102). If the external device 112 is not connected (S102, No), the process returns to the step S100 and repeat the steps. Hereby, while the external device 112 is not connected, the user-setting based time which the first time measurement unit 122 measures is displayed on the display 106.

If the external device 112 is connected (S102, Yes), the second time-information acquisition unit 124 acquires the information about a time of day of the external device 112 through the communication IF 108 from the device 112 (S104). On the basis of said information about a time of day acquired from the external device 112, the second time measurement unit 126 carries out time measurement and provides a current time calculated through the time measurement to the time display output unit 128 as a time synchronized with the external device 112. Then, the time display output unit 128 displays on the display 106 the time synchronized with the external device 112 provided from the second time measurement unit 126 (S106). Consequently, the user-setting based time displayed on the display 106 at the step S100 is overwritten with the time synchronized with the external device 112 which is in turn displayed on the display 106.

It is to be noted that the time synchronized with the external device 112 may start to be displayed on the display 106 in response to the time display output unit 128 receiving the notice of the connection of the external device 112 from the second time-information acquisition unit 124 and/or in response to the second time measurement unit 126 starting to provide the time synchronized with the external device 112.

Then, the second time-information acquisition unit 124 determines whether the external device 112 is disconnected from the time display device 100 (S108). If the external device 112 is not disconnected (S108, No), the process returns to the step S104 and repeats the procedure from the step S104. Hereby, while the external device 112 is connected with the time display device 100, the acquisition of the information about a time of day from the external device 112 and the display of the time synchronized with the external device 112 based on said information acquired from the device 112 are performed repeatedly.

If the external device 112 is disconnected (S108, Yes), the display of the time synchronized with the external device 112 on the display 106 continues on the basis of the information about a time of day which is acquired from the external device 112 at the last executed step S104 (S110). That is, the second time measurement unit 126 carries out the time measurement on the basis of the information about a time of day which is acquired from the external device 112 at the last executed step S104, and provides a current time calculated through the time measurement to the time display output unit 128 as the time synchronized with the external device 112. And then, the time display output unit 128 displays on the display 106 the time synchronized with the external device 112 provided from the second time measurement unit 126 (S110). And then, repeating the step S110, the time synchronized with the external device 112 continues to be displayed. This process flow terminates when the time display device 100 is turned off.

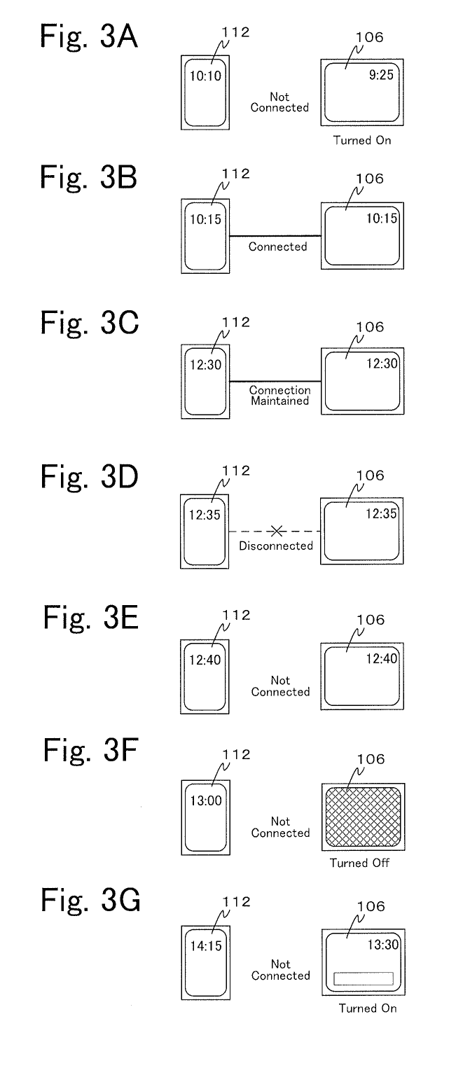

Exemplary changes of the time displays on the external device 112 and on the display 106 of the time display device 100 will now be explained with reference to FIGS. 3A-3G. FIG. 3A to FIG. 3G show exemplary time displays at different times, respectively. Each of these figures show a display screen of the display 106 of the time display device 100 (on the right in the figure) and a display screen of the external device 112 brought in the host vehicle (on the left in the figure), at a respective time. FIG. 3A to FIG. 3G are arranged in time order. And, in FIGS. 3A-3G, status of connection between the external device 112 and the time display device 100 is shown between these devices as “Not Connected”, “Connected”, “Connection Maintained”, or “Disconnected”. Further, “Turned on” or “Turned off” described below the time display device 100 on the right in these figures indicates that the time display device 100 is turned on or off, respectively, at a respective time.

First, in FIG. 3A, the time display device 100 is turned on. At this time, the connection status between the external device 112 and the time display device 100 is e.g. “not connected”, and each of the external device 112 and the time display device 100 may display a different time from each other. In the example shown in FIG. 3A, the external device 112 displays a time “10:10” which may be the standard time acquired from the wireless base station 114 (in FIG. 1), while the time display device 100 displays a user-setting based time which is 45 minutes before from the actual (correct) time, for example. Operation of the time display device 100 at this time corresponds to the step S100 and S102 in FIG. 2.

5 minutes later the external device 112 is connected to the time display device 100, as shown in FIG. 3B. Then, the time display device 100 executes the step S102 to S108 of FIG. 2 to acquire the information about a time of day from the external device 112 and display the time synchronized with the external device 112. As a result, as shown in FIG. 3B, the time display device 100 displays a time “10:15” which is the same as that displayed on the external device 112. The time display device 100 continues to display the time synchronized with the external device 112 while the connection between the external device 112 and the time display device 100 is maintained, as shown in FIG. 3C.

And, even though the external device 112 is disconnected afterwards from the time display device 100 (FIG. 3D), the time display device 100 continues to display the time synchronized with the external device 112 by using an internal clock (not shown) based on the information about a time of day last acquired from the external device 112 (FIG. 3E). This operation corresponds to the step S108 and S110 shown in FIG. 2.

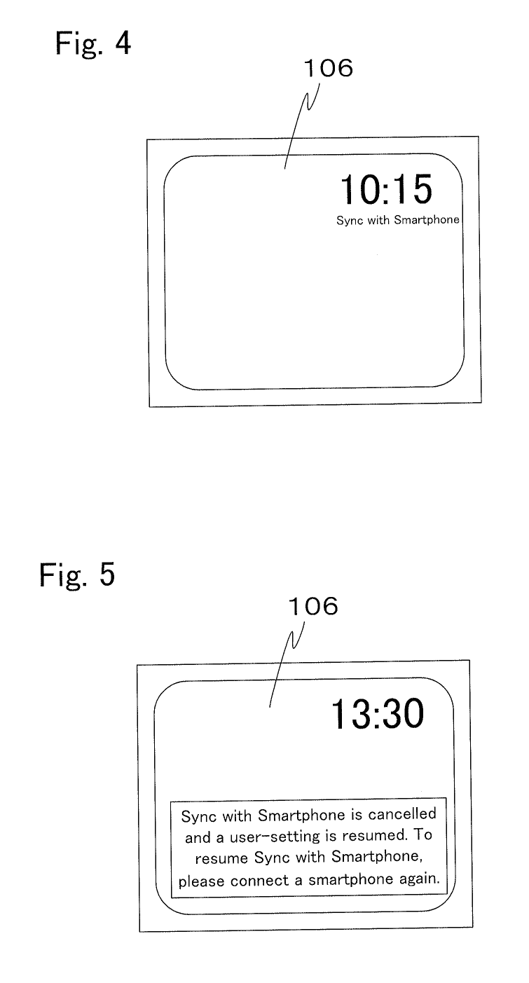

While the time synchronized with the external device 112 is displayed on the display 106 of the time display device 100, a text message of e.g. “Sync with Smartphone” may be displayed below the time display as shown in FIG. 4, which indicates that the display time is the time synchronized with the external device 112 (which is e.g. a smart phone in this example). Such indication of the display time being the time synchronized with the external device 112 is not limited to a text message and may be provided by a change of a foreground color (color of characters) or a background color in an area of the time display (e.g. the area of “10:15” in the figure). Further, alternatively or additionally to the text massage of “Sync with Smartphone”, in a case that the time synchronized with the external device 112 is the standard time which has been corrected at the time of crossing a time zone boundary, a text massage of “Corrected for Time Zone” may be displayed, and/or in a case that the display time is the time which has been corrected for the daylight saving time, a text message of “Corrected for DST” may be displayed.

Returning to FIGS. 3A-3G, the time display device 100 is turned off e.g. at the end of a driving cycle (FIG. 3F) and the time display on the display 106 of the time display device 100 terminates. Afterwards, if the time display device 100 is turned on e.g. by a new driving cycle being started (FIG. 3G), the user-setting based time (e.g. “13:30” in this example shown in FIG. 3G, which is 45 minutes before from the actual time) is displayed anew on the time display device 100 by the step S100, S102 of FIG. 2 being executed based on the previous user-entered time data, regardless of whether a time synchronization with the external device 112 was carried out during the previous driving cycle (FIG. 3G).

Additionally, when the time display device 100 is turned on anew, a text message indicating that the time synchronization with the external device 112 (which is e.g. a smart phone in this example) is cancelled may be displayed on the display 106, as shown in FIG. 5, for example.

### EXPLANATION OF REFERENCE NUMERALS

100 . . . time display device
102 . . . processing device
106 . . . display
108 . . . communication interface
110 . . . input/output interface
112 . . . external device
114 . . . wireless base station
116 . . . GPS satellite
120 . . . first time-information acquisition unit
122 . . . first time measurement unit
124 . . . second time-information acquisition unit
126 . . . second time measurement unit
128 . . . time display output unit

What is claimed is:

1. A time display device having a function of displaying time information, comprising
a processing device configure to:
measure and display a time based on a first time setting information which is input or previously input thereto;
in response to a predetermined device being connected thereto, acquire a second time setting information from the predetermined device;
measure and display a time based on a second time setting information instead of the time based on the first time setting information,
after starting to display the time based on the second time setting information, continue to display the time based on the second time setting information until the time display device is turned off, even though the predetermined device is disconnected.

2. The time display device according to claim 1, wherein
the processing device is further configured to:
continue a measurement of the time based on the first time setting information even after the time display device is turned off,
display the time based on the first time setting information at a time when the time display device is turned on.

3. The time display device according to claim 1, wherein the time display device is an audio device or a navigation device having a display.

4. The time display device according to claim 2, wherein the time display device is an audio device or a navigation device having a display.

5. A vehicle equipped with the time display device according to claim 1.
